(19) United States
(12) Patent Application Publication
(10) Pub. No.: US 2014/0336950 A1
(43) Pub. Date: Nov. 13, 2014

(54) CLUSTERING COPY-NUMBER VALUES FOR SEGMENTS OF GENOMIC DATA

(71) Applicant: University of North Dakota, Grand Forks, ND (US)

(72) Inventor: Ke Zhang, Grand Forks, ND (US)

(73) Assignee: Univerisity of South Dakota, GRank Folks, ND (US)

(21) Appl. No.: 14/358,599

(22) PCT Filed: Nov. 16, 2012
(86) PCT No.: PCT/US2012/065636

§ 371 Date: May 15, 2014

Related U.S. Application Data
(60) Provisional application No. 61/560,398, filed on Nov. 16, 2011.

(51) Int. Cl. G06F 19/22; G06F 19/24

(52) U.S. Cl. CPC G06F 19/22; G06F 19/24
USPC 702/20

(57) ABSTRACT

Clustering methods are disclosed including a hidden Markov model (HMM) based clustering algorithm having particular applicability for identifying tumor subtypes using array comparative genomic hybridization (aCGH) DNA copy number data. In one embodiment, clusters of tumor samples are modeled with a mixture of HMMs where each HMM fits a cluster of samples. With respect to this embodiment, a computationally efficient and fast clustering algorithm takes only a computational time of O(n), has less than half the error rate of non-negative matrix factorization (NMF) clustering, and can locate the optimal number of groups automatically (e.g., as applied to a data set including glioma aCGH data).

### CROSS-REFERENCE TO RELATED APPLICATIONS

This application claims the benefit of U.S. Provisional Application No. 61/560,398, filed Nov. 16, 2011, which is incorporated herein by reference in its entirety.

### STATEMENT REGARDING FEDERALLY SPONSORED RESEARCH

This invention was made with government support under Grant No. 2P20RR016471-09 awarded by the National Institutes of Health. The government has certain rights in the invention.

### BACKGROUND

1. Technical Field

The present disclosure relates to genomic data generally and more particularly to the analysis of genomic data by clustering methods.

2. Description of Related Art

Tumor progression is a complicated biological process that comes with enormous genetic and molecular changes, such as chromosome aberration, gene mutations, and activation or inhibition of transcriptional pathways. The abnormal genetic changes often show high variability even among tumors within the same histopathological subtype and anatomical origin, which may lead to variation in clinical outcomes. For example, a subtype of colorectal cancer, hereditary nonpolyposis (HNPCC), is characterized by dominant genetic defects in DNA mismatch repair pathway and HNPCC patients have higher 5-year survival than other subtypes of colorectal cancer patients (Myrhoj et al. (1997), Scand J Gastroenterol 32:572-576).

When genetic aberration is specific to a subset of tumors, it provides potent targets for chemotherapy. Examples include trastuzumab and lapatinib for treating HER2-positive breast cancers (Vogel et al. (2002), J Clin Oncol 20:719-726), tamoxifen for treating ER-positive breast cancers (Fisher et al. (1997), J Natl Cancer Inst 89:1673-1682; Cleator et al. (2009), Clin Breast Cancer 9 Suppl 1:S6-S17), and gefitinib and erlotinib for non-small cell lung cancer with EGFR mutations (Gazdar (2009), N Engl J Med 361:1018-1020; Cappuzzo et al. (2005), J Natl Cancer Inst 97:643-655; Laurent-Puig et al. (2009), Clin Cancer Res 15:1133-1139; Harris (2004), Lancet Oncol 5:292-302; Takano et al. (2005), J Clin Oncol 23:6829-6837).

DNA copy number aberration is a striking feature of tumor cells. During tumor progression, chromosomes are subjected to dramatic changes in that DNA segments are amplified, deleted, or translocated. Comparative genomic hybridization (CGH) technology has been a widely used tool for detecting changes in chromosome fragments. The advancement of array technology has enabled researchers to conduct array CGH (aCGH) study for profiling genome-wide chromosome variations using high-density array, such as single nucleotide polymorphism (SNP) array that contains from 100K to 3M SNP markers (Tan et al. (2008), Pathobiology 75:63-74). Such high dimensional DNA copy number data reveals genomic heterogeneity in many cancer types, ensuring biomarker discovery for each genomic subtype at SNP copy number level (Maher et al. (2006), Cancer Res 66:11502-11513).

Multiple clustering methods, including hierarchical clustering, Naive Bayes, K-nearest neighbors, support vector machine, probability model-based clustering, and nonnegative matrix factorization (NMF), have been developed and applied for aCGH data to identify tumor subtypes based on the DNA copy number aberrations (Myllykangas et al. (2006), Oncogene 25:7324-7332; Myllykangas et al. (2008), BMC Med Genomics 1:15; Carrasco et al. (2006), Cancer Cell 9:313-325; Wang et al. (2006), Oncol Rep 15 Spec no.:1057-1059). A revised version of NMF has been developed previously that showed improved performance for aCGH clustering when testing on three tumor types: non-small cell lung carcinoma, colorectal cancer and malignant melanoma (Lu et al. (2010), BMC Med Genomics 3:23). However, all these aforementioned methods fail to account for the spatial correlation between SNPs, and the correlation between adjunct SNPs could be as high as 0.99 for high density SNP arrays such as Affymetrix® 500K. Thus, there is a need for clustering methods that account for spatial correlations in aCGH data.

### SUMMARY

Certain embodiments enable improved clustering of copy-number values for segments of genomic data in order to classify genomic data samples. In a method according to one embodiment, a first operation includes accessing copy-number vectors that include copy-number values for samples that correspond to sources of the copy-number values, each copy-number vector including copy-number values at a plurality of markers that correspond to segments of genomic data for a corresponding sample. A second operation includes specifying a copy-number model for the copy-number values at the markers, the copy-number model including transitional probabilities from copy-number values at a given marker to copy-number values at a subsequent marker and evaluation probabilities for evaluating the copy-number values at the markers. A third operation includes specifying a first cluster grouping of the copy-number vectors for a plurality of clusters, each copy-number vector being associated with a cluster identification that identifies one of the clusters. A fourth operation includes using the copy-number model to evaluate a first likelihood value for the first cluster grouping by evaluating a corresponding likelihood value for each cluster of the first cluster grouping. A fifth operation includes specifying a second cluster grouping of the copy-number vectors by changing the cluster identification for at least one copy-number vector. A sixth operation includes using the copy-number model to evaluate a second likelihood value for the second cluster grouping by evaluating a corresponding likelihood value for each cluster of the second cluster grouping.

Certain specific embodiments relate to a Hidden Markov Model (HMM) based clustering algorithm and associated method having particular suitability for identifying tumor subtypes using aCGH DNA copy number data. In an exemplary embodiment, this approach properly models the high spatial correlation between aCGH markers. Clusters of tumor samples are modeled with a mixture of HMMs where each HMM fits a cluster of samples. More particularly, the HMMC algorithm is accurate and computationally efficient, takes only a computational time of O(n), has less than half the error rate of NMF clustering, and can locate the optimal number of groups automatically while applying to glioma aCGH data. The resulting clustering of glioma samples has strong association with overall survival time. This HMMC algorithm has wide application, including in tumor subtype identification, genomic signature discovery, and diagnostic and prognostic biomarker search, to name a few.

Another embodiment relates to an apparatus for carrying out any one of the above-described methods, where the apparatus includes a computer for executing instructions related to the method. For example, the computer may include a processor for executing at least some of the instructions. Additionally or alternatively the computer may include circuitry or other specialized hardware for executing at least some of the instructions. In some operational settings, the apparatus may be configured as a system that includes one or more units, each of which is configured to carry out some aspects of the method either in software, in hardware or in some combination thereof. At least some values for the results of the method can be saved for later use in a computer-readable medium, including memory units and storage devices. Another embodiment relates to a computer-readable medium that stores (e.g., tangibly embodies) a computer program for carrying out the any one of the above-described methods with a computer.

### BRIEF DESCRIPTION OF THE DRAWINGS

FIG. 1 is a diagram that shows a Hidden Markov Model (HMM) that is related to example embodiments.

FIG. 2 is a flowchart that shows a clustering method according to an example embodiment.

FIG. 3 is a plot that shows an HMMC error rate and an NMF error rate for an example embodiment.

FIG. 4A is a plot that shows convergence of the log-likelihood for an embodiment based on HMMC applied to the glioma data.

FIG. 4B is a plot that shows computing time for an embodiment based on HMMC applied to the glioma data.

FIG. 5 is a diagram that shows a heatmap of glioma clustering for an example embodiment.

FIG. 6 is a plot that shows Kaplan-Meier curves of glioma clusters for the embodiment of FIG. 5.

FIG. 7 is a flowchart that shows a method of clustering copy-number values for segments of genomic data according to an example embodiment.

FIG. 8 is a flowchart that shows a method of identifying a likelihood of an aberrant condition for a given human subject according to an example embodiment where each sample corresponds to a human subject whose genetic data is used to determine a corresponding copy-number vector.

FIG. 9 is a block diagram that shows a schematic representation of an apparatus for an example embodiment.

FIG. 10 is a block diagram that shows a computer processing system within which a set of instructions for causing the computer to perform any one of the methodologies discussed herein may be executed.

### DETAILED DESCRIPTION OF EXAMPLE EMBODIMENTS

### Overview

Disclosed herein are a data pre-processing procedure, comprising a hidden Markov model (HMM) and, in one embodiment, the model fitting for a cluster of aCGH samples; a machine-learning algorithm that uses HMMs to cluster tumors; and a fast implementation for the clustering algorithm and the approach to find the optimal number of groups.

A fast clustering algorithm has been developed having particular applicability to the identification of tumor subtypes based on DNA copy number aberrations. Recent advancements in array comparative genomic hybridization (aCGH) research have significantly improved tumor identification using DNA copy number data. A number of unsupervised learning methods, such as hierarchical clustering and non-negative matrix factorization (NMF), have been proposed for clustering aCGH samples. Nonetheless, these current methods assume independence between aCGH markers, while the markers are highly spatially correlated. The correlation between markers increases as their distance decreases. The independence assumption could lead to significant bias on the clustering result. Therefore, a mixture hidden Markov model based algorithm was developed to address this problem.

A hidden Markov model (HMM) is used to model the spatial correlation between aCGH markers. A fast clustering algorithm using machine learning technique was implemented and the computation time is proportional to the sample size O(n)). Simulation results showed that this HMM based clustering (HMMC) method has a substantially lower error rate than other clustering methods, such as NMF. Real data analysis on glioma aCGH data has shown that it converges to the optimal cluster rapidly and the HMMC results were significantly associated with clinical outcomes.

aCGH Data Segmentation

Raw data from Affymetrix® SNP array (AFFYMETRIX, INC., Santa Clara, Calif.) was preprocessed using the open source R package Aroma.affymetrix with the default parameters (Bengtsson et al. (2009), Bioinformatics 25:2149-2156). The resulting SNP-level copy numbers were segmented using circular binary segmentation (CBS) method within Aroma.affymetrix (Olshen et al. (2004), Biostatistics 5:557-572). The break points predicted by CBS at each sample were then summarized across all samples and the segments between pairs of adjunct break points were identified and the mean copy number of each segment was calculated for clustering analysis.

Because tumor specimen is often contaminated with normal tissues that are adjacent to them, which would complicate the analysis and introduce false negatives, it is necessary to conduct quality control to remove the normal contamination first. A machine-learning algorithm was developed to identify and filter out contaminated samples based on segmented copy number data. To conduct the quality control, two groups of samples were chosen; one with the highest number of copy number alteration regions and the other being normal samples. These two groups of samples served as a training dataset for a Random Forest classifier (Breiman (2001) Machine Learning 45:5-32) that was used to distinguish tumors and normal samples and identify signatures for tumor samples. The out of bag error rate of this classifier is usually very low (<5%). The trained classifier was then applied to all aCGH samples and a score of probability to be contaminated was calculated for each sample. Samples with a probability of more than 50% of contamination were excluded from further clustering analysis.

### HMM Fitting

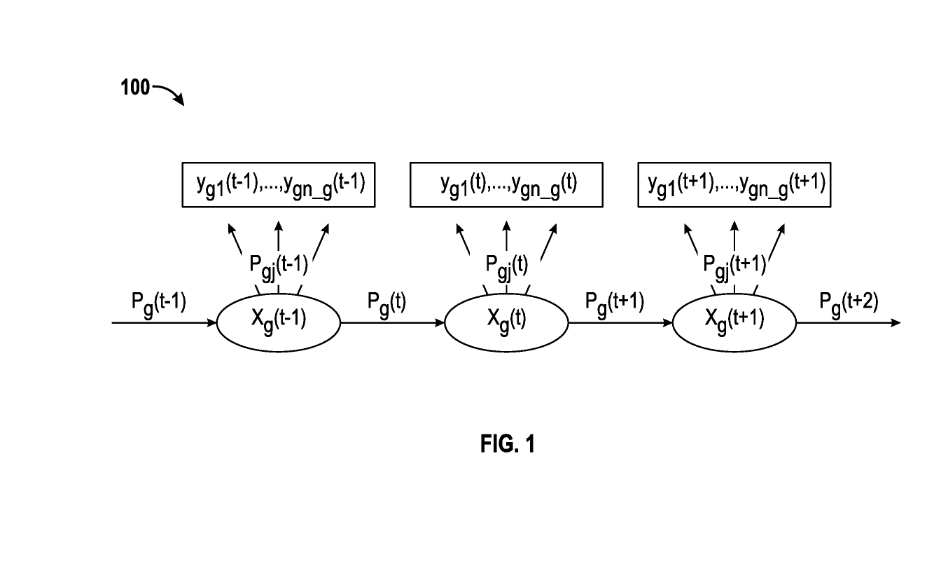

FIG. 1 shows an HMM 100 that relates to embodiments disclosed herein. As discussed below, a mixture HMM such as HMM 100 can be used to represent the clusters of tumor samples in that each cluster or subtype of tumors is modeled by a single HMM. Let t=1, . . . , T, denote the DNA segments of aCGH data. Suppose there are G clusters in total and there are n_{g} samples in cluster g, where g=1, . . . , G. The HMM for cluster g is demonstrated in FIG. 1. The hidden state at segment t is denoted as x_{g}(t), which is the true copy number of segment t and is unknown. The observed mean copy number for segment t and sample j is denoted as y_{gj}(t) where j=1, . . . , n_{g}. The transitional probability from state t−1 to t is denoted as P_{g}(t) and the emission probability from state t to observation y_{gj}(t) is denoted as P_{gj}(t).

Based on the distribution of segmentation copy number data, 6 states were chosen: xε{0.1, 1.5, 2, 3, 4, 5}. The transitional probabilities between states are given in a multinomial distribution that was empirically estimated from the raw data. For example, for the 79 glioma samples discussed herein, the transitional probability between the same states is 0.56, and is 0.088 otherwise. Lognormal distribution is widely used to model DNA copy number (Hodgson et al. (2001), Nat Genet 29:459-464). The emission probability was allowed to follow a lognormal distribution with the mean of the normal distribution being the hidden state value. The corresponding standard deviation of the normal distribution was empirically estimated as 0.148 from raw data using the mean standard deviation of segment copy number across all samples. A Viterbi algorithm was then used to fit this HMM to a cluster of tumor samples. The Viterbi algorithm is an efficient algorithm that uses a dynamic programming approach to estimate the hidden states from segment 1 to T and to calculate delta value, Δg, which is the log-likelihood for the model fitting of cluster g. The Viterbi algorithm was implemented in both R and C++ programming environments for this example embodiment.

### Sample Clustering

The optimal clustering is determined by the maximum sum of delta values from all groups. It is computationally infeasible to perform HMM fitting and calculate delta sum values for every possible clustering because the number of clustering for n samples G groups is Gⁿ. A computationally efficient algorithm has been developed for finding the clustering optima.

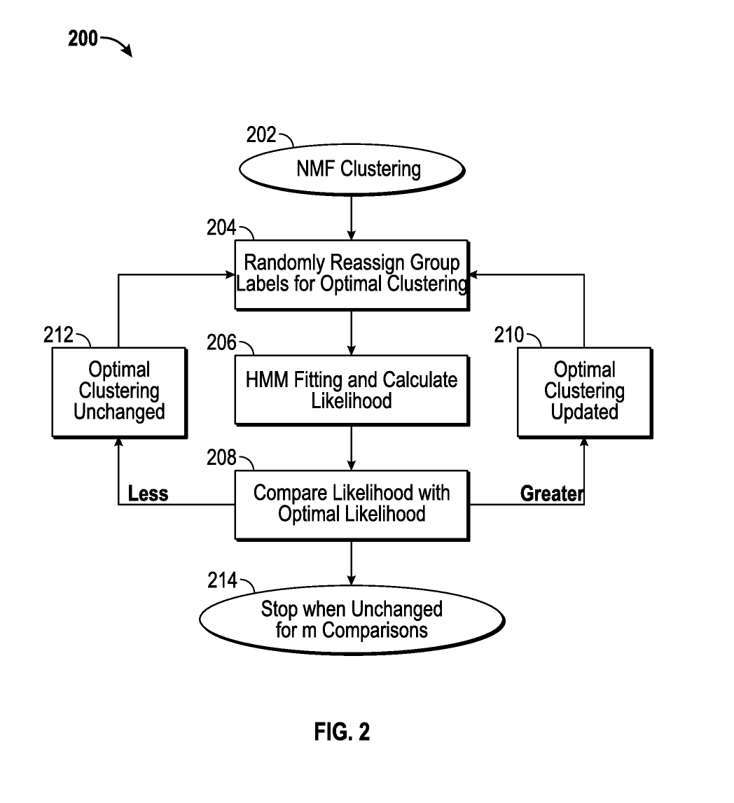

FIG. 2 shows a clustering method 200 according to an example embodiment. A first operation 202 includes an implementation of a Nonnegative Matrix Factorization (NMF) algorithm. That is, for a given number of groups G, an implementation of an NMF algorithm is executed to preliminarily cluster the samples. The NMF algorithm has been described previously (Lu et al., 2010). Though NMF classifies aCGH data without considering the correlation between markers, it has been shown to discover genomic signatures in various types of tumors (Maher et al. 2006; Lu et al. 2010). Thus, the clustering result of NMF serves as a starting point for HMM clustering. The next operation 204, which may be omitted in the first iteration based directly on the NMF clustering of operation 202, includes randomly reassigning one or more group labels for the samples. The next operation 206 includes an HMM fitting and a calculation of corresponding likelihood values. That is, an HMM was fit for each cluster from the previous step and calculate the sum of delta values, Δ1, . . . , ΔG. This is the log-likelihood for the current optimal clustering.

When the calculated likelihood value is greater than the currently accepted value, an update operation 210 is used to update the optimal clustering and accept the calculated likelihood value as the best value currently available, and the method 200 then continues to the operation 204 that randomly reassigns one or more group labels. When the calculated likelihood value is less than the currently accepted value, a no-update operation 212 is used to maintain current clustering and the currently accepted value, and the method 200 then continues to the operation 204 that randomly reassigns one or more group labels. The method 200 continues until a termination operation 214 is carried out based on a termination criterion. As shown in FIG. 2, the termination criterion may include stopping when the optimal likelihood value is unchanged for m comparisons (e.g., iterations). For example, in some operational setting it was found that m=n² is sufficient for HMMC to converge to the optimal clustering.

Both R and C++ have been used to implement this clustering algorithm. As the randomizing operations 204 can be performed simultaneously for multiple random clusterings, a parallel computing version of HMMC can be implemented to decrease the computation time. This was accomplished using the OpenMP package (Chandra (2001), Parallel programming in OpenMP. San Francisco, Calif.: Morgan Kaufmann Publishers. xvi, 230) within C++ to allow the random clustering and HMM fitting to be carried out across multiple threads in a multi-core machine. Each thread can update the optimal clustering and all threads share the same optima. This program has been tested in Dell® PowerEdge® R910 workstation (DELL, INC., Round Rock, Tex.) that has 32-cores and the parallel computing increased efficiency by an order of magnitude.

### Model Selection

One of the most difficult questions about clustering problem is to determine the number of groups, G. The HMMC algorithm of the present disclosure relies on a given G to find the optimal clustering. Thus model selection is needed to determine the best number of groups.

The Bayesian Information Criterion (BIC), a widespread statistical tool to conduct model selection, is used. BIC is defined as follows:

BIC=−2 ln L+k×ln(n),

where L is the likelihood which measures how good the HMM approximates the data, k is the number of parameters used in the model, and n is the number of samples. The second term, k ln(n), serves as a penalty on the number of parameters used in the model to avoid overfitting. Thus, the magnitude of penalty increases as the number G increases. A preferred model is selected upon a lower BIC value that indicates relatively higher likelihood as well as relatively lower risk of overfitting.

The sum of delta values is the log-likelihood for HMM fitting,

ln L=Σ_{g=1}^{G}Δg,

where Δ is the delta value of the gth group. Because the parameters for transitional and emission probability are empirically estimated, the number of unknown parameters k in BIC is equal to the number of hidden states. For an aCGH dataset with G groups and T segments, the number of parameters is equal to T×G. Thus, the BIC for HMM is defined as

BIC=−2Σ_{g=1}^{G}Δ_{g}+T×G×ln(n).

HMMC was run for a range of values of G, and select the optimal G with the smallest BIC.

### Cross-Validation for Testing Stability of HMMC

To assess the stability of HMMC results, a cross-validation was conducted as described earlier (Lu et al., 2010). After completing HMMC for the entire dataset, cross-validation was performed as follows. Ten percent (10%) of samples were randomly left out and HMMC was applied to the remaining 90% of samples; the clustering results were compared with the original one. The number of samples that are assigned to a different subgroup other than the original result is counted as errors. This procedure was repeated 100 times and the error rate calculated, which represents the stability of the clustering algorithm with respect to the permutation of samples.

### Simulation Study

In order to test the performance of HMMC, a simulation study was conducted to compare HMMC with NMF clustering. Two groups of aCGH data were created with 10 samples per group and 100 segments per each sample. For the first group, all data were generated from a normal distribution with mean equal to 2 and standard deviation equal to s, which was variable between different experiments. For the second group, the copy number of all segments followed a normal distribution as well. This normal distribution was the same as the first group, except that 3 segments in the middle of genome had a mean equal to 4 such that these 3 segments were amplified.

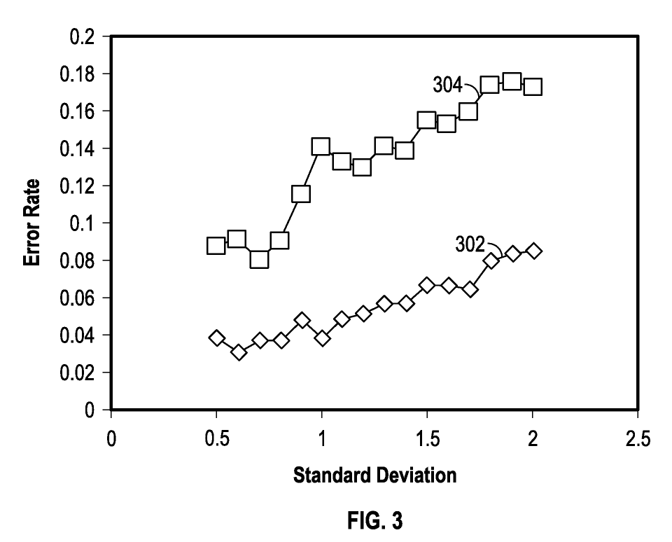

In order to introduce random noise, 40 segments were randomly drawn in all samples and their copy number values by increased by 2 (their mean was equal to 4). Thus, these 40 segments were randomly amplified segments. Furthermore, AR(1) correlation was introduced into the data. Considering the high correlation between SNPs in the high density SNP array, the pho value of AR(1) was set to be 0.9. HMMC and NMF were used to cluster the two groups with s value varying from 0.5 to 2. For each s, 200 aCGH datasets were generated and the number of samples mis-placed for either method was counted. FIG. 3 shows an HMMC error rate 302 and an NMF error rate 304 for an example embodiment where the same simulated data was tested with each model. In FIG. 3, the x-axis (s) is the standard deviation that was used to generate the data. T As illustrated in the figure, the error rates of both HMMC and NMF increase as the standard deviation s increases. The error rates of HMMC are in the range of 3% to 8.5%, whereas those for NMF are between 7.9% and 17.6%. Therefore, the observed chance for HMMC to incorrectly classify samples is less than half of that for NMF.

### Glioma Data

Glioma tissue aCGH data were acquired from Repository for Molecular BRAin Neoplasma DaTa (REMBRANDT)(National Cancer Institute 2005) (rembrandt.nci.nih.gov, Accessed Apr. 8, 2011). Affymetrix® 500K SNP array data were obtained along with the corresponding clinical information for 79 glioma patients. The aCGH data was first processed using Aroma.affymetrix software and was then segmented using circular binary segmentation method. This preprocessing step reduced the number of markers from 500K to 5321 segments. The segmented data was used for further analysis.

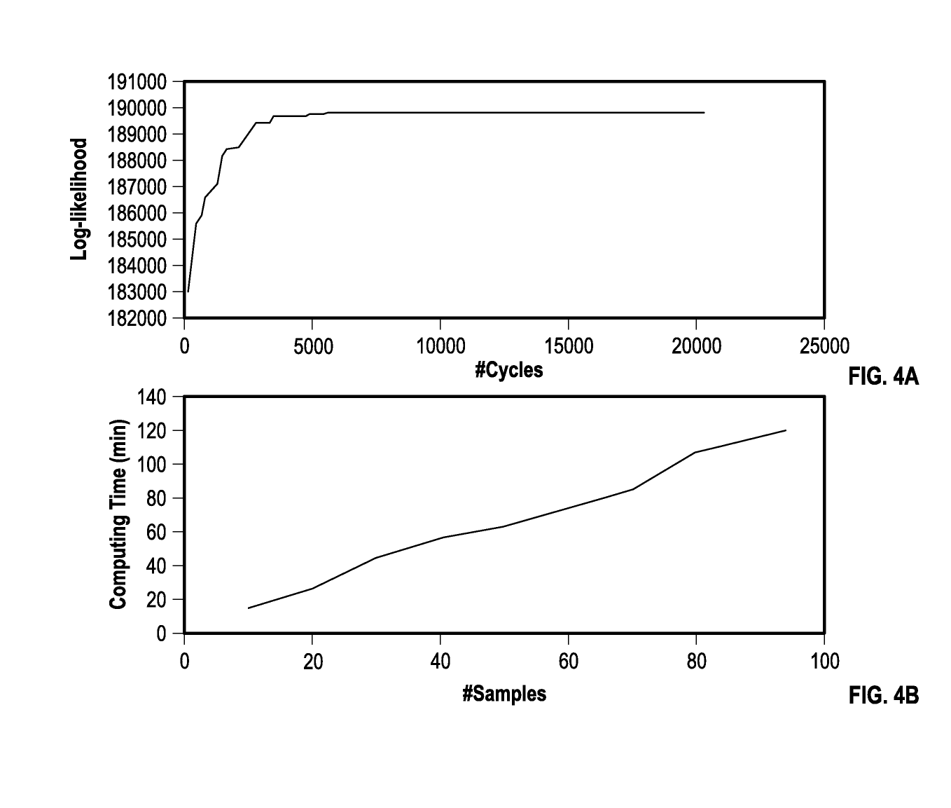

FIG. 4A shows convergence of the log-likelihood for an embodiment based on HMMC applied to the glioma data, and FIG. 4B shows the computing time for the embodiment based on HMMC applied to the glioma data. As illustrated in the Figures, the log-likelihood of HMMC converges rapidly to its maximum, and the computational time of HMMC is linear to the sample size. In this context, the first question to be addressed is the computational performance of HMMC when it is applied to high-dimensional data. The convergence rate of HMMC for glioma aCGH data was first tested assuming 2 groups. As shown in FIG. 4A, the log-likelihood of HMMC increases rapidly in the first 4,000 cycles of clustering, and it remains stable after 5,000 cycles. The log-likelihood reaches its maximum at approximately 15,000 cycles, and the computation stops after an additional 792=6241 cycles. Secondly, the computation time for different numbers of samples was tested. Random samples were drawn from the 79 glioma data. The numbers of random samples was from 10 to 95 and the number of groups was assumed to be 2. A Dell® PowerEdge® R910 was used to run 20 threads simultaneously for this test. FIG. 4B shows the curve of computation time. For 10 samples, it took less than 20 minutes. For 95 samples, it took about 2 hours to find the optimal clustering. The computation time is approximately linear to the number of samples (O(n)). Therefore, the clustering algorithm is computationally efficient and it achieves O(n) for the computational complexity.

To find the optimal number of groups, model selection was conducted using BIC. HMMC was run for the number of groups G from 2 to 6, and calculated the corresponding maximum log-likelihood and BIC. The results are shown in table 1.

TABLE 1
Model selection for glioma data

| #Group | 2 | 3 | 4 | 5 | 6 |
|---|---|---|---|---|---|
| Maximum | 162406 | 167661 | 169978 | 172476 | 175554 |
| log- | | | | | |
| likelihood | | | | | |
| BIC | −304617 | −305030 | −299567 | −294466 | −290524 |

The maximum log-likelihood increases as the number of groups increases because the model has a better fit for the data as the number of parameters increases. The BIC value was −304,617 for 2 groups, then it decreased to −305,030 for 3 groups, and then increased as the number of groups increased. Thus, the optimal number of groups is 3 because it gave the minimum value of BIC.

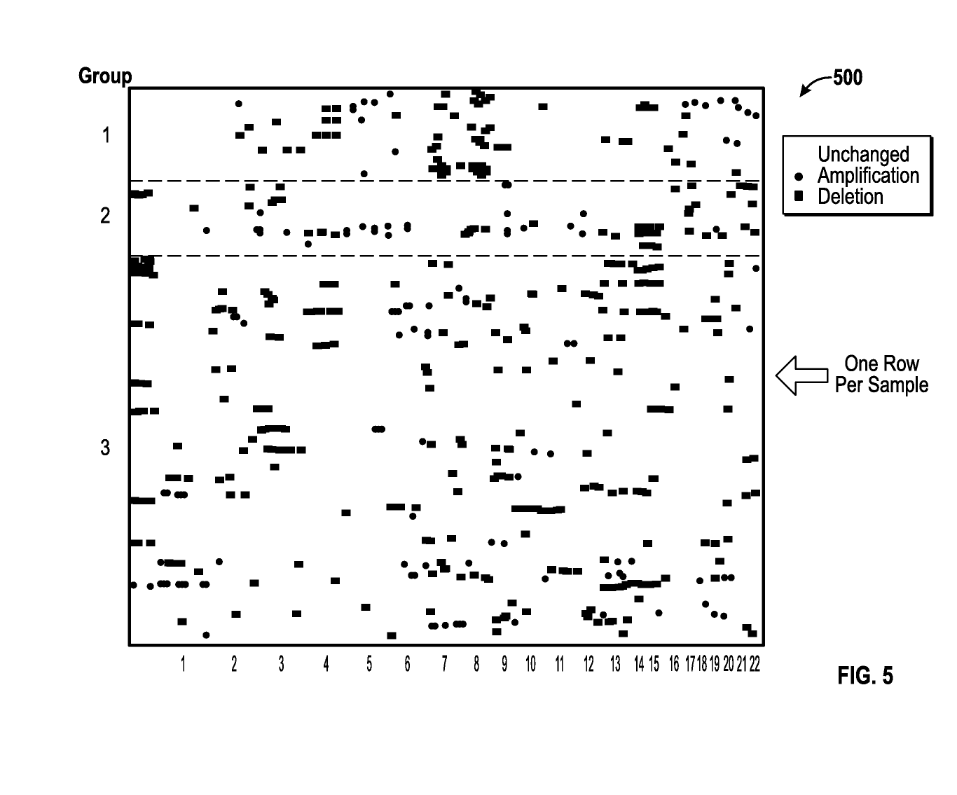

FIG. 5 is a diagram that shows the heatmap 500 of clustering the glioma samples into 3 groups. Each row of the heatmap 500 is a glioma sample, and each column is a DNA segment. There are 79 rows and 5,321 columns totally (e.g. one row for each sample). The segments are sorted in the order of genomic positions from chromosome 1 to 22. The sex chromosome was not included to avoid bias on gender. Most of the heatmap 500 is marked as “unchanged” to indicate no copy number variation (e.g., the copy number is equal to 2). Additionally, portions of the heatmap 500 are marked to indicate “amplification” (e.g., the copy number is greater than 2) and “deletion” (e.g., the copy number is less than 2). In FIG. 5, “unchanged” portions are indicated by white space, “amplification” portions are indicated by dark circles, and “deletion” portions are indicated by dark squares. The separations between the three groups are shown by the two horizontal dashed lines in the heatmap 500. Group 1 is characterized by large area of deletion in chromosome 8. Group 2 has amplification in various regions of chromosome 2 to 6 and deletion in chromosomes 17 and 18. Group 3 appears to have sparse aberrations in random regions.

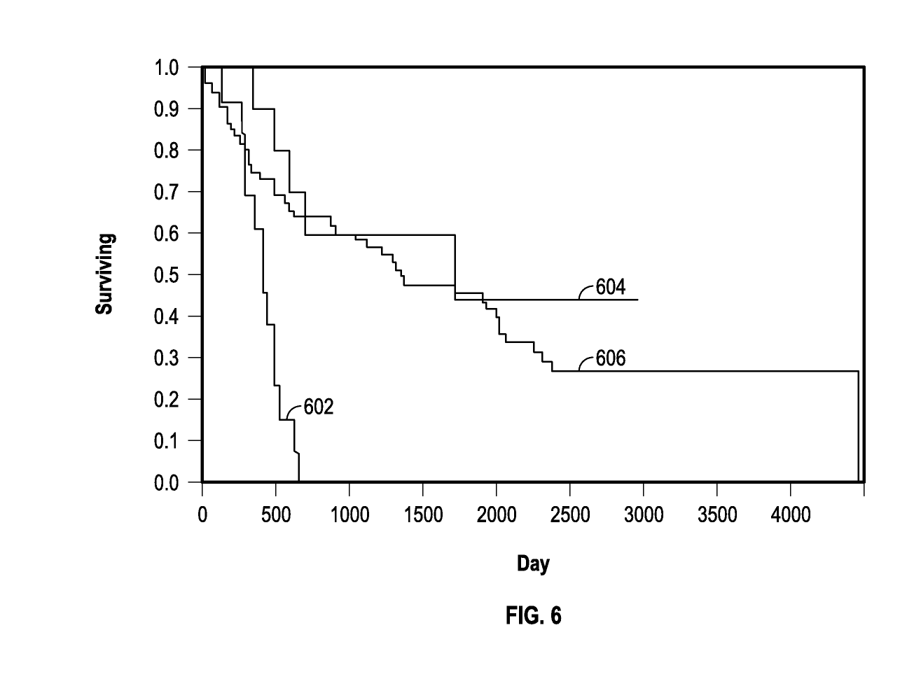

To verify the clustering results, survival analysis was performed on the 3 groups. The Kaplan-Meier curves are shown in FIG. 6 for the embodiment of FIG. 5 including the group-1 curve 602, the group-2 curve 604, and the group-3 curve 606. As shown in the figure, the median survival time for group 1 is 395 days, whereas those for group 2 and 3 are 1,698 and 1,337 days, respectively. Group 1 has a significant lower overall survival than group 2 and 3. The overall P value by log-rank test is less than 0.0001. Therefore, HMMC successfully clustered glioma samples based on aCGH data and the resulting tumor subtypes were associated with clinical outcomes. As discussed previously, group 2 manifests with large segments of deletion in chromosome 8. Thus genomic signature is identified for poor clinical outcome and they can serve as prognostic biomarkers. Upon identification of genes located in these abnormal genomics regions, the potential target for cancer therapy can be determined.

### Relevance to Genomic Applications

Genomic information has been increasingly used for molecular classifications of tumors because it provides a more objective view than histopathological approach and it sheds light on the molecular mechanisms of tumor heterogeneity. The global gene expression of major tumor types has been extensively studied for subtype identification (Shipp et al. (2002), Nat Med 8:68-74; Golub et al. (1999), Science 286:531-537; van't Veer et al. (2002), Nature 415:530-536; Alizadeh et al. (2000), Nature 403:503-511).

The fast development of SNP array has made it possible to characterize tumor subtypes based on the genomic DNA copy number, nonetheless, the computational and statistical methods in this area remain under-developed. In many aspects, DNA copy number is better than RNA expression data in terms of genomic signature and diagnostic or prognostic biomarkers. DNA is much easier to store than RNA because DNA is a stable molecule whereas RNA is transient and easy to degrade. In addition, RNA has to be collected from fresh tissues whereas DNA can be isolated from frozen or Paraform® (SAKURA FINETEK, U.S.A., INC., Torrance, Calif.) tissues even after years of storage. Furthermore, DNA aberration is preserved in the cell and can be passed to daughter cells via mitosis, whereas RNA expression is unstable and RNA levels are affected by many factors such as cell cycle, environmental and physiological factors. Therefore, tumor classification and genomic signature identification based on DNA copy number have extensive applications and improvements in the computational and statistical methods are needed to extend research in aCGH data analysis.

Most current statistical and data mining methods for aCGH data were developed from expression microarray analysis. An important difference between aCGH data and mRNA expression data is the high spatial correlation between neighboring SNPs in the aCGH data. The correlation between genes in expression microarray is relatively less and ignored by most methods that have been developed for such data. Thus most methods developed for expression microarray may yield significant false positives and false negatives when applied to the aCGH data. A clustering algorithm is disclosed that relies on HMM to take into account of the correlations between aCGH markers (SNPs). The HMMC algorithm performs better than the NMF clustering method, which is one of the most widely used methods used for aCGH sample clustering.

Though HMM has been widely used in modeling correlated data, such as DNA copy number data, it is widely known to be computationally very slow, especially for the analysis of high dimensional data such as the aCGH data. In order to overcome this problem, various approaches are used to increase the computational efficiency and speed. First, in the clustering procedure, a preliminary NMF clustering is conducted and the resulting groups are used as the starting point for HMMC. Secondly, instead of performing exhausting search, the current optimal clustering is disturbed only with a few random labelings. Thirdly, the algorithm implemented in C++ is much faster than R and MatLab® (MATHWORKS, INC., Natick, Mass.). Furthermore, a parallel computing version of the program has been developed, and it increases the speed of the server computer by over 10-fold. Testing on 79 glioma samples showed that HMMC rapidly converges to its optimal clustering and the computation time is linear to the sample size.

### Additional Embodiments

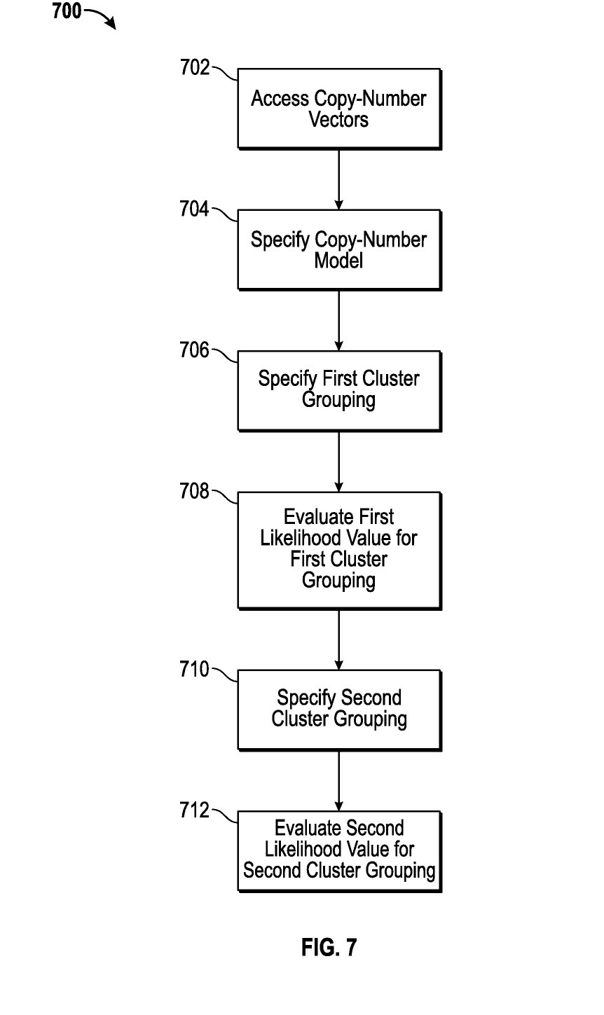

FIG. 7 shows a method 700 of clustering copy-number values for segments of genomic data according to an example embodiment. A first operation 702 includes accessing copy-number vectors that include copy-number values for samples that correspond to sources of the copy-number values, each copy-number vector including copy-number values at a plurality of markers that correspond to segments of genomic data for a corresponding sample. For example, each sample may corresponds to a human subject (e.g., a patient) whose genetic data is used to determine a corresponding copy-number vector, and each copy-number value may corresponds to a copy count for a corresponding segment of genomic data at a corresponding marker. (It should be noted that words such as first and second are used here and elsewhere for labeling purposes only and are not intended to denote any specific spatial or temporal ordering. Furthermore, the labeling of a first element does not imply the presence a second element.)

A second operation 704 includes specifying a copy-number model for the copy-number values at the markers, the copy-number model including transitional probabilities from copy-number values at a given marker to copy-number values at a subsequent marker and evaluation probabilities for evaluating the copy-number values at the markers. For example, the copy-number model may be provided based on the analysis of a genomic data set. As discussed above with respect to FIG. 1, the copy-number model may define a hidden Markov model with hidden states corresponding to copy numbers at the markers and observations corresponding to components of the copy-number vectors at the markers. For example, emission probabilities associated with the HMM may be used to evaluate the copy-number values at the markers in accordance with the properties of the multivariate Gaussian distribution. In an operational setting includes genomic data, the transitional probabilities may be determined by estimating values for transitions between copy numbers at adjacent markers for a sample in a genomic data set, and the evaluation probabilities may be determined by estimating variations between copy numbers at identical markers for different samples in the genomic data set. In particular, the copy-number transitions between adjacent markers may be used in order to capture the close spatial coupling across the genome (e.g. the chromosome values in FIG. 5)

A third operation 706 includes specifying a first cluster grouping of the copy-number vectors for a plurality of clusters, each copy-number vector being associated with a cluster identification that identifies one of the clusters. As discussed above with reference to FIG. 2, the first cluster grouping may be specified by first specifying a cluster group size that corresponds to a number of clusters for grouping the copy-number vectors and then performing a non-negative matrix factorization for a genomic data set corresponding to the copy-number vectors to determine a cluster identification for each of the copy-number vectors.

A fourth operation 708 includes using the copy-number model to evaluate a first likelihood value for the first cluster grouping by evaluating a corresponding likelihood value for each cluster of the first cluster grouping. For example, evaluating the first likelihood value for the first cluster grouping may include summing the likelihood values for the clusters to determine the first likelihood value, where the likelihood value for each cluster characterizes a joint probability for the corresponding copy-number vectors included in each cluster.

A fifth operation 710 includes specifying a second cluster grouping of the copy-number vectors by changing the cluster identification for at least one copy-number vector. A variety of randomizing methods may be used to perturb the cluster identifications of the copy number vectors including techniques from genetic algorithms (e.g., mutation, crossover). For example, specifying the second cluster grouping may include randomly selecting a first copy-number vector, where the first copy-number vector is associated with a first cluster identification, and then randomly changing the first cluster identification to a different cluster identification. Alternatively, specifying the second cluster grouping may includes randomly selecting a first copy-number vector, where the first copy-number vector is associated with a first cluster identification, randomly selecting a second copy-number vector, where the second copy-number vector is associated with a second cluster identification that is different from the first cluster identification, and then switching values between the first cluster identification and the second cluster identification.

A sixth operation 712 includes using the copy-number model to evaluate a second likelihood value for the second cluster grouping by evaluating a corresponding likelihood value for each cluster of the second cluster grouping. As discussed above with reference to FIG. 2, the second cluster grouping may be accepted as a replacement for the first cluster grouping when the second likelihood value is greater than the first likelihood value. Additional embodiments may include maintaining a finite list of the top cluster groupings (e.g, from the top ten likelihood values encountered) and generating multiple cluster groupings in parallel.

As discussed above with reference to FIG. 2, the process may be continued until some termination criterion is achieved (e.g., no improvement or minimal improvement such as less than 1% in the estimated likelihood value). For example the method 700 may include determining a sequence of cluster groupings including the first cluster grouping and the second cluster grouping, where a given cluster grouping is used to determine a subsequent cluster grouping by changing the cluster identification for at least one copy-number vector relative to the given cluster grouping, and then monitoring likelihood values corresponding to the sequence of cluster groupings and terminating the sequence at a final cluster grouping in accordance with a threshold condition for convergence of the likelihood values.

As discussed above with reference to the Bayesian Information Criterion (BIC) and issues of model overfitting, an information metric may be used to evaluate the cluster group size that corresponds to the number of clusters used for grouping the copy-number vectors. In general, an information metric such the BIC is improved by larger likelihood values and smaller cluster sizes.

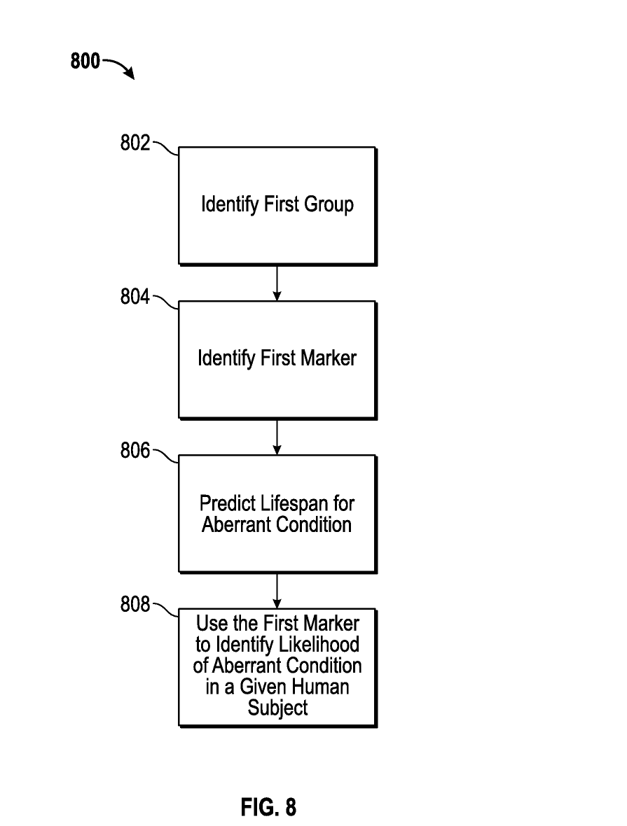

As discussed above with reference to FIGS. 5 and 6, the method 700 may be extended to identify markers where copy-number variations are correlated with aberrant conditions and life expectancies. FIG. 8 shows a method 800 of identify a likelihood of an aberrant condition for a given human subject according to an example embodiment where each sample corresponds to a human subject whose genetic data is used to determine a corresponding copy-number vector. A first operation 802 includes identifying a first group from the second cluster grouping, where the first group is associated with an aberrant condition (e.g., glioma or a glioma subtype) for each human subject included in the first group. A second operation 804 includes identifying a first marker from the plurality of markers, where the first maker is associated with copy-number values that are different from a nominal copy-number value for human subjects included in the first group (e.g., markers at chromosome 8 for group 1 in FIG. 5). A third operation 806 includes predicting a lifespan corresponding to the aberrant condition from lifespan data for the human subjects included in the first group (e.g., as in FIG. 6). For example, the predicted lifespan may correspond to a mean value or median value from a lifespan data set.

Typically the copy-number values that are different from the nominal copy-number value may correspond to a specified set of copy-number values (e.g., values less than 2 for “deletion” or values greater than 2 for “amplification” as in FIG. 5). A fourth operation 808 then includes using the first marker to identify a likelihood of the aberrant condition in a given human subject by identifying a copy-number value from the specified set of copy-number values at the first marker for the given human subject.

Additional embodiments correspond to systems and related computer programs that carry out the above-described methods.

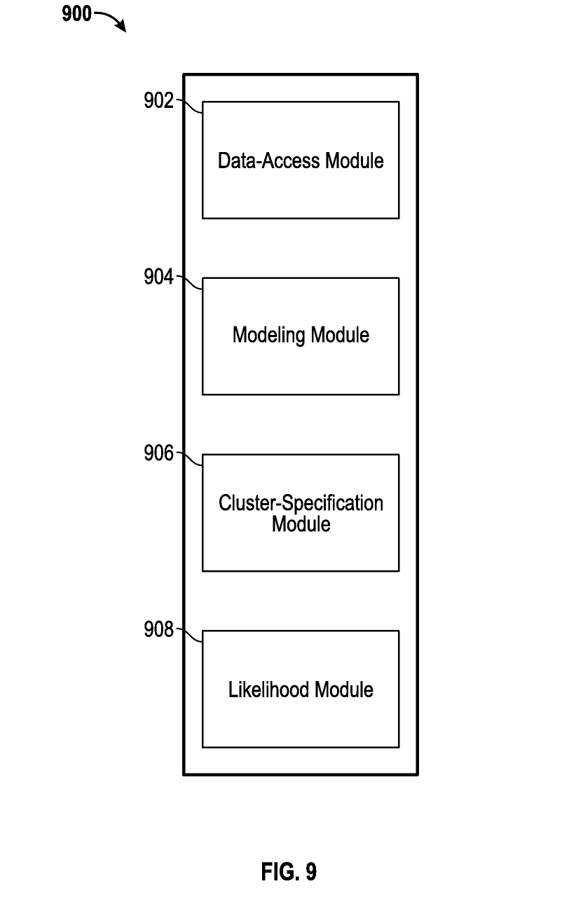

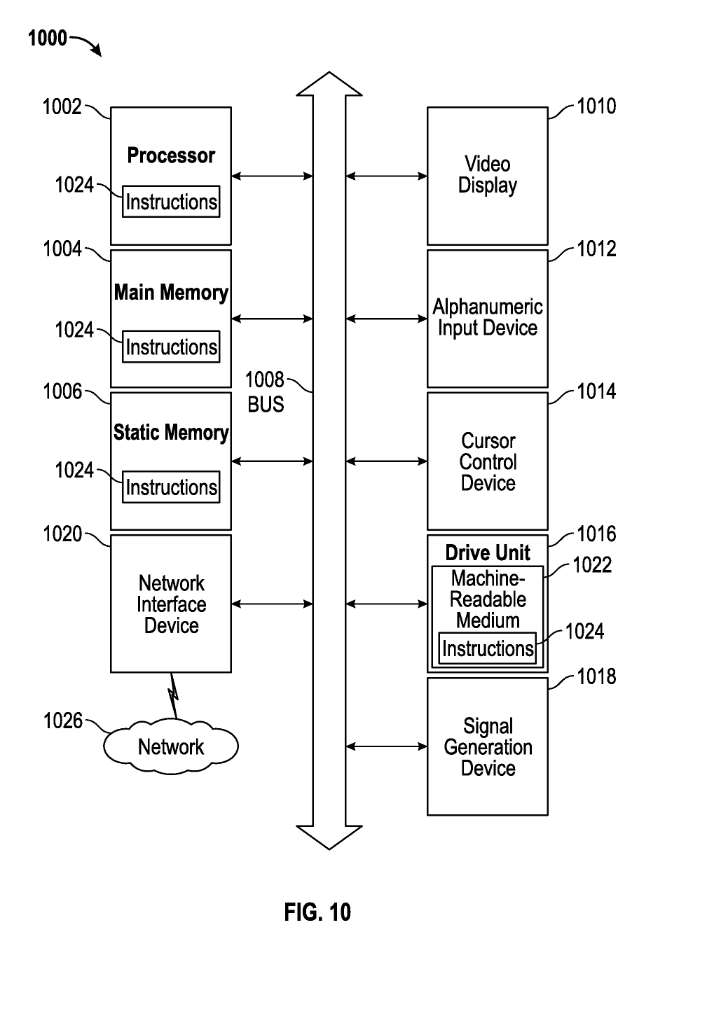

FIG. 9 shows a schematic representation of an apparatus 900, in accordance with an example embodiment, for clustering copy-number values of segments of genomic data. In this case, the apparatus 900 includes at least one computer system (e.g., as in FIG. 10) to perform software and hardware operations for modules that carry out aspects of the method 700 of FIG. 7.

In accordance with an example embodiment, the apparatus 900 includes a data-access module 902, a modeling module 904, a cluster-specification module 906, and a likelihood module 908. The data-access module 902 operates to accesses a plurality of copy-number vectors that include copy-number values for a plurality of samples that correspond to sources of the copy-number values, each copy-number vector including copy-number values at a plurality of markers that correspond to segments of genomic data for a corresponding sample. The modeling module 904 operates to specify a copy-number model for the copy-number values at the markers, the copy-number model including transitional probabilities from copy-number values at a given marker to copy-number values at a subsequent marker and evaluation probabilities for evaluating the copy-number values at the markers.

The cluster-specification module 906 operates to cluster-specification module that specifies a plurality of cluster groupings of the of the copy-number vectors for a plurality of clusters, each copy-number vector being associated with a cluster identification that identifies one of the clusters for each cluster grouping, and the cluster groupings including a first cluster grouping and a second cluster grouping that is specified by changing the cluster identification for at least one copy-number vector relative to first cluster grouping. The likelihood module 908 operates to use the copy-number module to evaluate a likelihood value for a cluster grouping by evaluating a corresponding likelihood value for each cluster of the cluster grouping. Additional operations related to the method 700 may be performed by additional corresponding modules or through modifications of the above-described modules.

### Computer Systems

FIG. 10 shows a machine in the example form of a computer system 1000 within which instructions for causing the machine to perform any one or more of the methodologies discussed here may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system woo includes a processor 1002 (e.g., a central processing unit (CPU), a graphics processing unit (GPU) or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) cursor control device 1014 (e.g., a mouse), a disk drive unit 1016, a signal generation device 1018 (e.g., a speaker), and a network interface device 1020.

In some contexts, a computer-readable medium may be described as a machine-readable medium. The disk drive unit 1016 includes a machine-readable medium 1022 on which is stored one or more sets of data structures and instructions 1024 (e.g., software) embodying or utilizing any one or more of the methodologies or functions described herein. The instructions 1024 may also reside, completely or at least partially, within the static memory 1006, within the main memory 1004, or within the processor 1002 during execution thereof by the computer system 1000, with the static memory 1006, the main memory 1004, and the processor 1002 also constituting machine-readable media.

While the machine-readable medium 1022 is shown in an example embodiment to be a single medium, the terms “machine-readable medium” and “computer-readable medium” may each refer to a single medium or multiple media (e.g., a centralized or distributed database, and/or associated caches and servers) that store the one or more sets of data structures and instructions 1024. These terms shall also be taken to include any tangible or non-transitory medium that is capable of storing, encoding or carrying instructions for execution by the machine and that cause the machine to perform any one or more of the methodologies disclosed herein, or that is capable of storing, encoding or carrying data structures utilized by or associated with such instructions. These terms shall accordingly be taken to include, but not be limited to, solid-state memories, optical media, and magnetic media. Specific examples of machine-readable or computer-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; compact disc read-only memory (CD-ROM) and digital versatile disc read-only memory (DVD-ROM).

The instructions 1024 may further be transmitted or received over a communications network 1026 using a transmission medium. The instructions 1024 may be transmitted using the network interface device 1020 and any one of a number of well-known transfer protocols (e.g., hypertext transfer protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Certain embodiments are described herein as including logic or a number of components, modules, or mechanisms. Modules may constitute either software modules or hardware-implemented modules. A hardware-implemented module is a tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module (e.g., a computer-implemented module) may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” (e.g., a “computer-implemented module”) should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation and store the output of that operation in a memory device to which it is communicatively coupled. A further hardware-implemented module may then, at a later time, access the memory device to retrieve and process the stored output. Hardware-implemented modules may also initiate communications with input or output devices and may operate on a resource (e.g., a collection of information).

The various operations of example methods described herein may m be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

### CONCLUSION

Although only certain embodiments have been described in detail above, those skilled in the art will readily appreciate that many modifications are possible without materially departing from the novel teachings of this disclosure. For example, aspects of embodiments disclosed above can be combined in other combinations to form additional embodiments. Accordingly, all such modifications are intended to be included within the scope of this disclosure.

1. A method of clustering copy-number values for segments of genomic data, the method comprising:
accessing a plurality of copy-number vectors that include copy-number values for a plurality of samples that correspond to sources of the copy-number values, each copy-number vector including copy-number values at a plurality of markers that correspond to segments of genomic data for a corresponding sample;
specifying a copy-number model for the copy-number values at the markers, the copy-number model including transitional probabilities from copy-number values at a given marker to copy-number values at a subsequent marker and evaluation probabilities for evaluating the copy-number values at the markers;
specifying a first cluster grouping of the copy-number vectors for a plurality of clusters, each copy-number vector being associated with a cluster identification that identifies one of the clusters;
using the copy-number model to evaluate a first likelihood value for the first cluster grouping by evaluating a corresponding likelihood value for each cluster of the first cluster grouping;
specifying a second cluster grouping of the copy-number vectors by changing the cluster identification for at least one copy-number vector; and
using the copy-number model to evaluate a second likelihood value for the second cluster grouping by evaluating a corresponding likelihood value for each cluster of the second cluster grouping.

2. The method of claim 1, wherein each sample corresponds to a human subject whose genetic data is used to determine a corresponding copy-number vector.

3. The method of claim 1, wherein each copy-number value corresponds to a copy count for a corresponding segment of genomic data at a corresponding marker.

4. The method of claim 1, wherein the copy-number model defines a hidden Markov model with hidden states corresponding to copy numbers at the markers and observations corresponding to components of the copy-number vectors at the markers.

5. The method of claim 1, wherein specifying the copy-number model includes:
estimating values for transitions between copy numbers at adjacent markers for a sample in a genomic data set to determine the transitional probabilities; and
estimating variations between copy numbers at identical markers for different samples in the genomic data set to determine the evaluation probabilities.

6. The method of claim 1, wherein specifying the first cluster grouping includes:
specifying a cluster group size that corresponds to a number of clusters for grouping the copy-number vectors; and
performing a non-negative matrix factorization for a genomic data set corresponding to the copy-number vectors to determine a cluster identification for each of the copy-number vectors

7. The method of claim 1, wherein evaluating the first likelihood value for the first cluster grouping includes summing the likelihood values for the clusters to determine the first likelihood value, the likelihood value for each cluster characterizing a joint probability for the corresponding copy-number vectors included in each cluster.

8. The method of claim 1, wherein specifying the second cluster grouping includes:
randomly selecting a first copy-number vector, the first copy-number vector being associated with a first cluster identification; and
randomly changing the first cluster identification to a different cluster identification.

9. The method of claim 1, wherein specifying the second cluster grouping includes:
randomly selecting a first copy-number vector, the first copy-number vector being associated with a first cluster identification;
randomly selecting a second copy-number vector, the second copy-number vector being associated with a second cluster identification that is different from the first cluster identification; and
switching values between the first cluster identification and the second cluster identification.

10. The method of claim 1, further comprising:
accepting the second cluster grouping as a replacement for the first cluster grouping when the second likelihood value is greater than the first likelihood value.

11. The method of claim 1, further comprising:
evaluating an information metric for the copy-number model, the information metric being based on a cluster size that corresponds to a number of clusters for a cluster grouping and a likelihood value for the cluster grouping, and the information metric being improved by larger likelihood values and smaller cluster sizes.

12. The method of claim 1, further comprising:
determining a sequence of cluster groupings including the first cluster grouping and the second cluster grouping, a given cluster grouping being used to determine a subsequent cluster grouping by changing the cluster identification for at least one copy-number vector relative to the given cluster grouping; and
monitoring likelihood values corresponding to the sequence of cluster groupings and terminating the sequence at a final cluster grouping in accordance with a threshold condition for convergence of the likelihood values.

13. The method of claim 1, wherein each sample corresponds to a human subject whose genetic data is used to determine a corresponding copy-number vector, and the method further comprises:
identifying a first group from the second cluster grouping, the first group being associated with an aberrant condition for each human subject included in the first group; and
identifying a first marker from the plurality of markers, the first maker being associated with copy-number values that are different from a nominal copy-number value for human subjects included in the first group.

14. The method of claim 13, wherein the copy-number values that are different from the nominal copy-number value correspond to a specified set of copy-number values, and the method further comprises:
using the first marker to identify a likelihood of the aberrant condition in a given human subject by identifying a copy-number value from the specified set of copy-number values at the first marker for the given human subject.

15. The method of claim 13, further comprising:
predicting a lifespan corresponding to the aberrant condition from lifespan data for the human subjects included in the first group.

16. A non-transitory computer-readable medium that stores a computer program to cluster copy-number values for segments of genomic data, the computer program including instructions that, when executed by at least one computer, cause the at least one computer to perform operations comprising:
accessing a plurality of copy-number vectors that include copy-number values for a plurality of samples that correspond to sources of the copy-number values, each copy-number vector including copy-number values at a plurality of markers that correspond to segments of genomic data for a corresponding sample;
specifying a copy-number model for the copy-number values at the markers, the copy-number model including transitional probabilities from copy-number values at a given marker to copy-number values at a subsequent marker and evaluation probabilities for evaluating the copy-number values at the markers;
specifying a first cluster grouping of the copy-number vectors for a plurality of clusters, each copy-number vector being associated with a cluster identification that identifies one of the clusters;
using the copy-number model to evaluate a first likelihood value for the first cluster grouping by evaluating a corresponding likelihood value for each cluster of the first cluster grouping;
specifying a second cluster grouping of the copy-number vectors by changing the cluster identification for at least one copy-number vector; and
using the copy-number model to evaluate a second likelihood value for the second cluster grouping by evaluating a corresponding likelihood value for each cluster of the second cluster grouping.

17.-22. (canceled)

23. The non-transitory computer-readable medium of claim 16, wherein specifying the second cluster grouping includes:
randomly selecting a first copy-number vector, the first copy-number vector being associated with a first cluster identification; and
randomly changing the first cluster identification to a different cluster identification.

24. The non-transitory computer-readable medium of claim 16, wherein specifying the second cluster grouping includes:
randomly selecting a first copy-number vector, the first copy-number vector being associated with a first cluster identification;
randomly selecting a second copy-number vector, the second copy-number vector being associated with a second cluster identification that is different from the first cluster identification; and
switching values between the first cluster identification and the second cluster identification.

25. The non-transitory computer-readable medium of claim 16, wherein the computer program further includes instructions that, when executed by the at least one computer, cause the at least one computer to perform operations comprising:
accepting the second cluster grouping as a replacement for the first cluster grouping when the second likelihood value is greater than the first likelihood value.

26.-30. (canceled)

31. An apparatus configured to cluster copy-number values for segments of genomic data, the apparatus comprising at least one computer configured to perform operations for computer-implemented modules including:
a data-access module that accesses a plurality of copy-number vectors that include copy-number values for a plurality of samples that correspond to sources of the copy-number values, each copy-number vector including copy-number values at a plurality of markers that correspond to segments of genomic data for a corresponding sample;
a modeling module that specifies a copy-number model for the copy-number values at the markers, the copy-number model including transitional probabilities from copy-number values at a given marker to copy-number values at a subsequent marker and evaluation probabilities for evaluating the copy-number values at the markers;
a cluster-specification module that specifies a plurality of cluster groupings of the of the copy-number vectors for a plurality of clusters, each copy-number vector being associated with a cluster identification that identifies one of the clusters for each cluster grouping, and the cluster groupings including a first cluster grouping and a second cluster grouping that is specified by changing the cluster identification for at least one copy-number vector relative to first cluster grouping; and
a likelihood module that uses the copy-number module to evaluate a likelihood value for a cluster grouping by evaluating a corresponding likelihood value for each cluster of the cluster grouping.

32.-37. (canceled)
